(19) United States
(12) Patent Application Publication
(10) Pub. No.: US 2025/0264174 A1
(43) Pub. Date: Aug. 21, 2025

(54) BIDIRECTIONALLY OPERABLE QUICK COUPLER ASSEMBLY

(71) Applicants: Kody J. KETTERLING, Twin Falls, ID (US); Cameron Troy WILLIAMS, Kimberly, ID (US)

(72) Inventors: Kody J. KETTERLING, Twin Falls, ID (US); Cameron Troy WILLIAMS, Kimberly, ID (US)

(21) Appl. No.: 19/060,591

(22) Filed: Feb. 21, 2025

Related U.S. Application Data
(60) Provisional application No. 63/556,345, filed on Feb. 21, 2024.

(51) Int. Cl. F16L 37/098

(52) U.S. Cl. CPC F16L 37/0982

(57) ABSTRACT

A quick coupler assembly includes a female body having an internal channel between a first end and a second end. An outer shell is coupled to and partially encloses the female body and is movable between the first and second ends. A male body includes a protrusion that extends from a platform and defines an internal flow channel therethrough. The protrusion is configured to removably engage the internal channel of the female body to define a single open channel through the assembly. The assembly includes a means for locking the protrusion in the female body, and another means for releasing the protrusion from the female body. The releasing means may be activated by a one-quarter turn of the outer shell relative to the male body in either a clockwise or counterclockwise direction.

### RELATED APPLICATIONS

This application claims priority to U.S. Provisional Application No. 63/556,345 filed Feb. 21, 2024, the contents of which are fully incorporated herein by reference.

### BACKGROUND OF THE INVENTION

### Field of the Invention

The present invention relates generally to pipe fittings, and more particularly, to a quick coupler for connecting upstream and downstream components in an irrigation system.

### Description of Related Art

Conventional couplers utilized in sprinkler systems can include barbed couplers and threaded couplers. Barbed couplers are known to include a body and at least one end having one or more annular rows of barbs or protrusions that can be pressed into an inner surface of the engaged pipe section. The annular barbs are oriented so that the pipe section cannot be easily pulled off the coupler. Threaded couplers typically have a male or female threaded end that will engage complementary threads, e.g., either female or male, on the complementary part. Threaded couplers may be threaded on both ends or may include at least one barbed end. The style of the coupler will determine the type of upstream and downstream connection thereto.

Conventional couplers can be time consuming to install and may not always provide a desired fluid seal at the connection point. For instance, barbed couplers require an operator to force the barbed end into a pipe section with sufficient force to overcome the barbs. Depending on the material of the pipe section, installation of a barbed coupler may not be possible by hand alone and can require use of a tool, such as a rubber mallet or a hammer, to drive the coupler into the pipe section. Regardless of the materials, installation of barbed couplers typically requires the operator to use both hands so that one hand can hold the pipe section while the other hands forces the barbed end into the pipe section. The operator must ensure the barbed coupler is concentrically aligned with the pipe section prior to driving the coupler therein or else the barbs can pierce through the pipe section resulting in leakage.

In the case of threaded couplers, the operator must have a sufficiently large working area cleared to ensure the threads on both component pieces are clean to allow for the threaded engagement. In sprinkler systems, this requirement may be exacerbated by the fact that threaded couplers are commonly buried underground, requiring the operator to excavate a large working area to ensure the threads remain free from debris. For this reason, the operator will usually need to use both hands to install the threaded coupler.

A further downside to existing irrigation couplers is that once the coupler is installed, it becomes difficult to remove. In fact, many times an operator cannot remove the coupler and instead must cut the section of pipe which is engaged to the coupler to facilitate its removal. Both barbed couplers and threaded couplers suffer this disadvantage. A key reason for the difficulty in removing these known coupler types is that both ends are typically engaged to a pipe section, and those pipe sections are typically buried underground. The buried pipe section makes disengaging the threads of a threaded coupler difficult because neither end can be readily rotated without cutting away the buried pipe to free up one end or exposing a sufficient length that will allow the operator to rotate one side relative to the other. Similarly, barbed couplers are purposefully designed to be difficult to remove because the barbs are oriented to arrest movement when pulled in a reverse or decoupling direction. Removal of barbed couplers typically requires an operator to heat the pipe section with a torch before pulling the coupler out. However, this may deform the pipe section which was engaged to the coupler, therefore necessitating a cutting away of that section.

Thus, what is needed is a coupler that can be quickly and reliably deployed using only one hand to connect a fluid source to a sprinkler system.

### SUMMARY OF THE INVENTION

The above problems are addressed by a bidirectionally operable quick coupler assembly according to the present invention. The quick coupler assembly disclosed herein can easily be installed and removed by an operator, requiring only one free hand and no additional tools. When used in irrigation systems, the quick coupler assembly can be easily removed without having to cut away part of the water line to which the assembly is coupled.

In one preferred embodiment, the quick coupler assembly includes a female body, an outer shell, and a male body. The female body includes a first end, a second end and an internal channel extending between the first end and the second end. The outer shell is coupled to and movable over the female body. Preferably, the outer shell partially encloses the female body and is movable between the first end and the second end. The male body includes a platform and a protrusion extending from the platform. The protrusion removably engages the internal channel of the female body to define a single open channel through the assembly. The assembly also includes a means for locking the protrusion in the female body and a separate means for releasing the protrusion from within the female body.

The female body may include one or more free floating locking tabs. Preferably, the locking tabs extend through the outer surface of the female body and partially into the internal channel thereof. The outer shell may also include one or more rails extending along the inner surface of the outer shell. In preferred embodiments, the one or more rails are positioned to slidably engage the one or more locking tabs arranged around the female body. A compression spring may surround the female body and similarly be enclosed by the outer shell. The compression spring is configured to bias the outer shell toward the second end of the female body, which causes the one or more rails to engage the one or more locking tabs. In preferred embodiments, the protrusion of the male body includes an annular notch that is configured to engage with the one or more locking tabs.

The locking means preferably involves the spring causing the one or more rails to engage the one or more locking tabs, moving the tabs partially into the internal channel where the tabs engage the annular notch formed around the protrusion of the male body. The locking means locks the protrusion within the internal channel of the female body until the releasing means is activated.

In some embodiments, the male body also includes opposing crests extending from a perimeter of the platform. The crests preferably extend in the same direction as the protrusion. The outer shell may also include opposing lips extending around a perimeter of a distal end away from the female body. The opposing lips are configured to rotatably engage the opposing crests. In preferred embodiments, the releasing means include the rotational engagement of the opposing lips with the opposing crests. The rotational engagement between the lips and the crests disengages the locking means to release the protrusion from within the female body. Due to the lips engaging the crests, the spring is compressed and the outer shell is moved toward the first end of the female body, which disengages the one or more rails from the one or more locking tabs thereby allowing the protrusion to be withdrawn from the female body. Preferably, the assembly is bidirectionally operable, which means the releasing means can be activated by either a clockwise or counterclockwise rotation.

The second end of the female body may include an annular rim, the annular rim extending toward the inner surface of the outer shell. The outer shell may also include an internal rim formed at the distal end, proximate the second end of the female body. A plurality of fingers extend from the internal rim and are configured to engage the annular rim of the female body to limit axial movement of the outer shell beyond the second end. The female body may also include an annular ledge formed around the first end and extending radially outward toward the outer shell. Similarly, the outer shell may include a block extending from the inner surface toward the female body. The block is configured to engage a portion of the annular ledge when the outer shell is moved toward the first end of the female body, the engagement limiting the axial movement of the outer shell off the female body in the direction of the first end.

In further embodiments, the coupler assembly includes a female body, an outer shell movably enclosing the female body, a male body engageable within the female body, and a means for bidirectionally rotatably disengaging the male body from within the female body. Preferably, the bidirectional disengagement means is configured so that a one-quarter clockwise or counterclockwise turn of the outer shell relative to the male body releases the male body from within the female body. The female body may include an internal locking means for locking the male body within the female body, where the internal locking means is deactivated by the bidirectional disengagement means. In further embodiments, the male body is configured to press-fit into the female body.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is a side view of an embodiment of a quick coupler assembly according to the present invention.

FIG. 2 is an exploded side view of an embodiment of a quick coupler assembly according to the present invention.

FIG. 3 is a perspective end view of an embodiment of the outer shell and the female body of a quick coupler assembly according to the present invention.

FIG. 4 is an end view of an embodiment of a quick coupler assembly according to the present invention.

FIG. 5A is a first cross-sectional side view, taken along line A-A marked in FIG. 4, of an embodiment of a quick coupler assembly in a locked or resting position.

FIG. 5B is a magnified view of the circle B marked in FIG. 5A.

FIG. 6A is a second cross-sectional side view, taken along line A-A marked in FIG. 4, of an embodiment of a quick coupler assembly in an unlocked position, where the outer shell and the female body are rotated substantially 90-degrees in comparison to that shown in FIG. 5A.

FIG. 6B is magnified view of the circle C marked in FIG. 6A.

### DETAILED DESCRIPTION OF THE INVENTION

The following disclosure presents exemplary embodiments for a bidirectionally operable quick connection coupler assembly, or quick coupler assembly, that can reliably connect two components in line in a fluid system, such as a water source to a sprinkler head. The quick coupler assembly according to the present invention provides an operator with the ability to easily remove the connected component without having to cut away the pipe section. Further, only one end of the quick coupler assembly needs to be exposed to facilitate its removal. The quick coupler assembly is engineered so that a one-quarter bidirectional turn of one end relative to the other decouples the assembly. As used herein, bidirectional should be understood to mean in either a clockwise or counterclockwise direction. The quick coupler assembly therefore is engineered to decouple when one end is rotated in either a clockwise or counterclockwise direction relative to the other end of the assembly, as will detailed further below.

The bidirectionally operable quick coupler assembly can be installed by simply pushing one end (e.g. the male body) of the assembly into the other end (e.g. the female body) with a relatively low amount of force to overcome the internal locking mechanism. Installation and removal can therefore be accomplished using a single hand and requiring no additional tools. These and other features and advantages of the quick coupler assembly according to the present invention will be detailed further below.

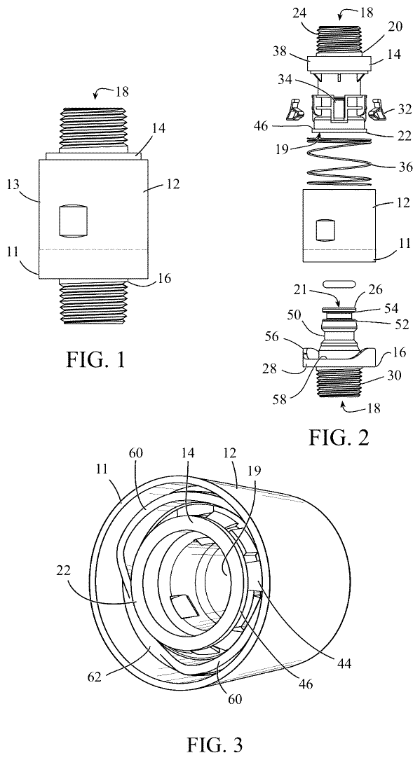

FIG. 1 is a side view of an embodiment of a quick coupler assembly according to the present invention. The quick coupler assembly 10 includes an outer shell 12 enclosing a female body 14. The female body 14 is engineered to removably engage a male body 16. The outer shell 12 includes a skirt 11 formed around a lower end, the skirt configured to enclose a portion of the male body 16 when the male body 16 is engaged with the female body 14. The quick coupler assembly 10 includes a means for locking the male body 12 into the female body 14 and another means for releasing the male body 16 from the female body 14. The releasing means may be activated by a one-quarter bidirectional, i.e., clockwise or counterclockwise, turn of the outer shell 12 relative to the male body 16, as detailed further herein. When assembled together, a hollow channel 18 extends through both of the female body 14 and the male body 16. When assembled, the hollow channel 18 is continuous and may be described as a single, hollow channel 18. With regard to the female body 14, hollow channel 18 may be described as the female channel 19. Similarly, with regard to the male body 16, the hollow channel 18 may be described as the male channel 21. It should be understood when the male body 16 engages the female body 14, the male channel 21 and the female channel 19 are fluidically linked to form the hollow channel 18 extending through the quick coupler assembly 10.

FIG. 2 is an exploded side view of an embodiment of a quick coupler assembly according to the present invention. The female body 14 has a first end 20 and an opposite second end 22. In some embodiments, a threaded protrusion 24 extends from the first end 20, the threads being complimentary to internal threads formed on an upstream component, such as a conventional sprinkler engaged to the quick coupler assembly 10. In alternative embodiments, a barbed protrusion may extend from the first end 20. The second end 22 is configured to receive the male body 16 into the female channel 19 extending through the female body 14. The outer shell 12 encloses the female body 14 and is moveable over the female body 14 between the first end 20 and the second end 22 thereof. The skirt 11 of the outer shell 12 preferably extends beyond the second end 22 of the female body 14 when the quick coupler assembly 10 is in a resting or locked position, such as shown in FIG. 1. When the quick coupler assembly 10 is in an unlocked position, the outer shell 12 is moved so that the distal end of the skirt 11 is coplanar with the second end 22 of the female body 14, as will be explained in more detailed below.

The male body 16 includes a protrusion 26 extending from a platform 28. A second threaded end 30 extends from the platform 28 in direction opposite the protrusion 26. The second threaded end 30 may also be configured as a barbed end, according to conventional coupling designs. The protrusion 26 is configured to be press-fit through the second end 22 of the female body 14 to engage the internal locking means formed in the female channel 19. In preferred embodiments, the protrusion 26 includes an annular notch 50 defined at an intermediate position along the length of the protrusion. Forward of the notch 50, an O-ring 52 may be engaged around a terminal end 54 of the protrusion. When assembled, the O-ring 52 creates and maintains a fluidic seal with the inner surface of the female channel 19.

The male body 14 also includes opposing crests 56 extending upward from a perimeter of the platform 28. The crests 56 are formed on substantially opposites sides of the platform 28 and are separated by opposing low tracks 58 forming a remainder of the perimeter of the platform 28. Thus, the low tracks 58 and the crests 56 form a smooth, continuous outer perimeter of the platform 28. As used herein, smooth is meant to mean no sharp corners or abrupt edges. As will be detailed further below, the platform 28 rotatably cooperates with the outer shell 12 to effectuate the means for releasing the male body 16 from the female body 14.

The female body 14 may include one or more free floating locking tabs 32 extending through one or more windows 34 defined in the female body 14. The free floating locking tabs 32 extend partially into the female channel 19. A spring 36 encircles the female body 14 and is also enclosed by the outer shell 12. The spring 36 is configured to bias the outer shell 12 in the direction of the second end 22 of the female body 14, as shown in the resting or locked configuration illustrated by FIG. 1.

FIG. 3 is a perspective end view of the outer shell enclosing the female body according to one embodiment of the invention, the view taken from the second end of the female body. The skirt 11 extends beyond the second end 22 when the coupler assembly 10 is in a resting or locked position. The outer shell 12 includes a main shell body 13 defining a thickness T. The skirt 11 extends beyond the main shell body 13. Extending from the main shell body 13 are opposing lips 60 which are separated from one another by a high track 62. The distance between each of the lips 60 is preferably greater than a length of the crests 56 extending from the platform 28 of the male body 16.

FIG. 4 is an end view, taken from the first end of the female body, of the quick coupler assembly according to the present invention. The channel 18 is visible and can be seen extending substantially through the coupler assembly 10. The outer shell 12 encloses the female body 14. The thickness T of the outer shell 12 can be clearly seen from this view. The protrusion 26 is engaged to the female body 14 and is positioned in the channel 18. FIG. 4 marks section lines A-A, which are commonly used to denote the cross-sections illustrated by the following figures.

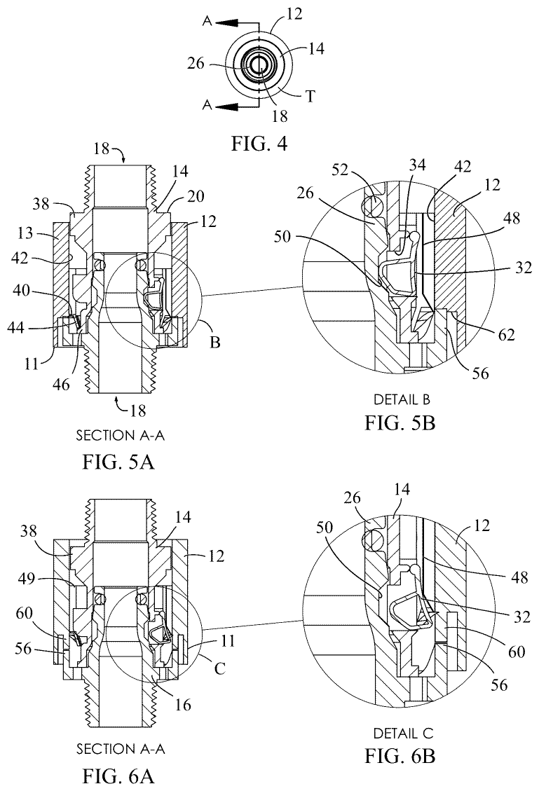

FIG. 5A is a cross-sectional view, taken along lines A-A marked in FIG. 4, of an embodiment of the quick coupler assembly according to the present invention. FIG. 5A illustrates the quick coupler assembly 10 in a locked position. FIG. 5B is a magnified view of circle B marked in FIG. 5A. For the sake of simplicity in the drawings, the spring 36 has been excluded from these cross-sectional views. In some embodiments, the female body 14 includes an annular ledge 38 formed around the first end 20, the annular ledge 38 engaging one end of the spring 36. The opposite end of the spring 36 is engaged to an internal rim 40 formed about the inner surface 42 of the main shell body 13 of the outer shell 12. The spring 36 is configured to bias the outer shell 12 away from the first end 20 and toward the second end 22. The outer shell 12 can be moved toward the first end 20 of the female body 14 by compressing the spring 36 longitudinally. The outer shell 12 and the spring 36 are concentrically aligned around the female body 14. A plurality of fingers 44 extend from the internal rim 40 of the outer shell 12, the fingers 44 engaging an annular rim 46 formed around the second end 22 of the female body 14. Engagement between the fingers 44 and the rim 46 ensures that the spring 36 does not force the outer shell 12 off the female body 14 in the direction of the second end 22. The engagement between the fingers 44 and the annular rim 46 is also shown in the perspective view of FIG. 3.

In some embodiments, the outer shell 12 further includes a mechanical block 49 extending inward from the inner surface 42 thereof. The spring 36 can be arranged over the mechanical block 49 so that the block 49 extends partially into the circumference of the spring 36, e.g., the block 49 extends between adjacent coils of the spring 36 when assembled. In alternative embodiments, the spring 36 may be arranged between the block 49 and the ledge 38 of the female body 16. The mechanical block 49 is configured to engage a portion of the ledge 38 when the quick coupler assembly 10 is moved to an unlocked position. Engagement between the mechanical block 49 and the ledge 38 keeps the outer shell 12 from coming off the female body 14 in the direction of the first end 20. Further, the mechanical block 49 extending inward toward the female body 14 causes the outer shell 12 to cooperatively rotate with the female body 14 so the two components rotate together around a common axis. Engagement between the mechanical block 49 and the ledge 38 can be seen more clearly in FIG. 6A discussed below. In further embodiments, other means for movably locking the outer shell 12 around the female body 14 may be provided.

FIG. 5B is a magnified view of detail B marked in FIG. 5A. The inner surface 42 of the outer shell 12 includes one or more rails 48 formed longitudinally thereon. Preferably, the rails 48 align with the one or more locking tabs 32 so that when the outer shell 12 is biased toward the second end 22 of the female body 14, the rails 48 engage with the locking tabs 32 to press the tabs through the windows 34 and partially into the female channel 19. The outer shell 12 is movable over the female body 14 between the locked position shown in FIGS. 5A and 5B and an unlocked position shown in FIGS. 6A and 6B.

In the locked position shown in FIGS. 5A and 5B, the outer shell 12 is biased toward the second end 22 causing the rails 48 to engage the locking tabs 32 pressing the tabs 32 partially into the female channel 19. The outer shell 12 preferably rests in the locked position. In the locked position, the crests 56 are aligned with the high tracks 62 portion of the outer shell 12, so that the crest 56 are positioned between the lips 60.

In preferred embodiments, the internal locking means include the one or more locking tabs 32 being forced partially into the female channel 19 by the one or more rails 48 under the compressive force of the spring 36 moving the outer shell 12 toward the second end 22 of the female body 14. The locking tabs 32 are configured to engage the annular notch 50 formed around the protrusion 26 when the male body 16 is inserted into the female body 14, thereby locking the male body 16 and the female body 14 together.

Engagement of the male body 16 with the female body 14 is relatively simple and can be accomplished using only one hand when the quick coupler assembly 10 is engaged to irrigation components in both the upstream and downstream direction, e.g., a water line coupled to the threaded end 30 of the male body 16 and a sprinkler engaged to threads 24 of the female body 14. The protrusion 26 of the male body 16 is pressed into the female channel 19 with sufficient force to overcome the locking tabs 32, which temporarily compresses the spring 36 thereby releasing the rails 48 from the locking tabs 32. An operator continues to press the protrusion 26 into the female channel 19 until the annular notch 50 is engaged with the locking tabs 32, allowing the rails 48 to reengage the locking tabs 32. The locking tabs 32 engaged to the annular notch 50 secure the male body 16 within the female body 14. The O-ring 52 at the terminal end 54 of the protrusion creates and maintains a fluid seal around the inner surface of the female channel 19. The hollow channel 18 extending through the female body 14 and the male body 16 forms a fluidically sealed environment.

FIG. 6A is cross-sectional view, taken along the common line A-A marked in FIG. 4, of the quick coupler assembly in an unlocked position. When compared to the views shown among FIGS. 5A and 5B, the outer shell 12 coupled with the female body 14 has been rotated substantially 90-degrees clockwise or counterclockwise while the male body 16 remains in the same position. The bidirectional rotation, i.e., clockwise or counterclockwise, of the outer shell 12 and female body 14 relative to the male body 16 activates the releasing means causing the locking tabs 32 to disengage from the annular notch 50 to release the protrusion 26 of the male body 16 from within the female body 14.

In preferred embodiments, the releasing means comprises the bidirectional rotational engagement of the lips 60 extending from the outer shell 12 with the crests 56 extending from the platform 28. The rotational engagement between the lips 60 with the crests 56 moves the outer shell 12 toward the first end 20 of the female body 14, compressing the spring 36. The movement of the outer shell 12 toward the first end 20 disengages the rails 48 from the locking tabs 32, thereby allowing the protrusion 26 to be withdrawn from the female channel 19. The locking tabs 32 being free floating in the windows 34 allows for the easy withdraw of the male body 16 once the tension is relieved from the tabs 32 due to the temporary disengagement from the rails 48.

More specifically, the releasing means is activated by the bidirectional rotation of the outer shell 12 relative to the male body 16 which causes the lips 60 to ride along the low track 58 area and up the crests 56, thereby moving the outer shell 12 toward the first end 20 of the female body 14. As the outer shell 12 moves toward the first end 20, the rails 48 temporarily disengage from the locking tabs 32, thereby releasing the locking tabs 32 from the annular notch 50 and allowing the male body 16 to withdrawn from the female body 14. The combined length or height of the crests 56 plus the lips 60 is sufficient to move the outer shell 12 to release the male body 16 from the female body 14 without requiring any additional tools. The releasing means can be activated by an operator using only one hand, and no external tools, by simply rotating the outer shell 12 and female body 16 in a clockwise or counterclockwise direction while the male body 16 remains stationary.

As the outer shell 12 is moved toward the first end 20 of the female body 14, the block 49 may engage with a portion of the ledge 38 to prevent the outer shell 12 from sliding off the female body 14 in the direction of the first end 20. In alternative embodiments, an arrangement of internal tabs, similar to fingers 44, may be formed around the proximal end of the outer shell 12 and engineered to engage a portion of the ledge 38 at the first end 20 of the female body 14.

A one-quarter bidirectional turn of the outer shell 12 relative to the male body 16 causes the crests 56 to completely engage the lips 60 thereby releasing the male body 16 from the female body 14. The bidirectionally operable quick coupler assembly 10 is particularly useful for attaching end components in an irrigation system, such as the sprinklers at the end of a water line. The quick coupler assembly 10 provides an operator with the means to easily swap out different sprinklers without having to completely expose a buried water line and/or cut away sections of a water line engaged to existing couplers. An operator may need only to expose a sufficient amount of the sprinkler enclosure to grasp and rotate it. Rotation of a sprinkler enclosure deployed with the quick coupler assembly 10 will cause the outer shell 12 and female body 14 to similarly rotate activating the releasing means. The bidirectional rotation ability to activate the releasing means allows an operator to rotate the sprinkler enclosure engaged to the female body 14 in either direction, ensuring that the sprinkler enclosure does not inadvertently disengage while the operator is attempting to activate the releasing means. The male body 16 coupled to the water line remains buried and is stationary due to the surrounding soil. The operator can replace the sprinkler attached to the female body 16 by disengaging the sprinkler enclosure from threads 24. The new sprinkler can be threaded onto the threads 24 and thereafter redeployed in the vacated area left in the soil by the previous sprinkler. Once the protrusion 26 is aligned within the female channel 19, the operator can press downwards and rotate the sprinkler slowly until the crests 56 are aligned along the high tracks 62, which alignment the operator will feel and hear due to the locking tabs 32 engaging with the annular notch 50. The operator can check the connection by attempting to pull the sprinkler from the ground. When the locking means are properly activated, the operator will not be able to pull the sprinkler from the ground.

The quick coupler assembly 10 according to the present invention can be manufactured according to known injection molding techniques, utilizing known polymer materials. Alternatively, the quick coupler may printed using conventional additive manufacturing processes, such as 3-dimensional printing. Various types of known polymer materials may be used to manufacture the quick coupler according to the present invention. These may include polymers such as acrylonitrile butadiene styrene (ABS), polylactic acid (PLA), and various other types of polyamides or nylon materials. Depending on the manufacturing process used and the final requirements for the quick coupler, individual component pieces thereof may be formed from the same or different materials. For example, any of the components discussed herein may be formed from any of various metals commonly used in irrigation systems and other fluid systems. It should also be understood that the quick coupler invention as disclosed herein is not limited to the connection of sprinklers, and can be used to connect any two components in a mechanical piping system that form a channel for directing fluid flow, such as pipe sections, elbows, tees, valves, and fittings. The invention may also be used to couple together sections of electrical conduit and also electrical connectors. In more elaborate embodiments of the present invention, a bidirectionally operable quick coupler may be useful for attaching any two components in which it is preferred to have the ability to quickly decouple while otherwise maintaining a secured connection, such as necklace chain.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A coupler assembly, comprising:
a female body having a first end, a second end, and an internal channel extending between the first end and the second end;
an outer shell coupled to, and movable over the female body, wherein the outer shell is configured to partially enclose the female body and be movable between the first end and the second end;
a male body having a platform, a protrusion extending from the platform, and a flow channel defined therethrough, the protrusion removably engaged within the internal channel of the female body to define a single open channel;
a means for locking the protrusion in the female body; and
a means for releasing the protrusion from the female body.

2. The coupler assembly of claim 1, wherein the female body further comprises one or more locking tabs extending through an outer surface of the female body and partially into the internal channel.

3. The coupler assembly of claim 2, wherein the outer shell further comprises one or more rails extending along an inner surface of the outer shell, the one or more rails configured to slidably engage the one or more locking tabs.

4. The coupler assembly of claim 3, further comprising a compression spring surrounding the female body and enclosed by the outer shell, wherein the compression spring is configured to bias the outer shell toward the second end of the female body causing the one or more rails to engage the one or more locking tabs.

5. The coupler assembly of claim 4, wherein the protrusion further comprises an annular notch.

6. The coupler assembly of claim 5, wherein the locking means comprises the compression spring causing the one or more rails to engage the one or more locking tabs to move partially into the internal channel and engage the annular notch of the protrusion.

7. The coupler assembly of claim 1, wherein the male body further comprises opposing crests formed around a perimeter of the platform, the crests extending upward in a common direction with the protrusion.

8. The coupler assembly of claim 7, wherein the outer shell further comprises opposing lips extending from a perimeter of a distal end and away from the female body.

9. The coupler assembly of claim 8, wherein the opposing lips are configured to rotatably engage the opposing crests.

10. The coupler assembly of claim 9, wherein the releasing means comprises the rotational engagement of the opposing lips with the opposing crests, wherein the rotational engagement between the opposing lips and the opposing crests disengages the locking means to release the protrusion from the female body.

11. The coupler assembly of claim 10, wherein the releasing means is bidirectionally operable.

12. The coupler assembly of claim 1, wherein the second end of the female body further comprises an annular rim extending toward an inner surface of the outer shell.

13. The coupler assembly of claim 12, wherein the outer shell further comprises an internal rim formed at a distal end and having a plurality of fingers extending downward therefrom, wherein the plurality of fingers movably engage the annular rim to secure the outer shell around the female body at the second end.

14. The coupler assembly of claim 13, wherein the female body further comprises an annular ledge formed at the first end and extending radially outward toward the outer shell.

15. The coupler assembly of claim 14, wherein the outer shell further comprises a block extending from an inner surface toward the female body, wherein the block is configured to movably engage the annular ledge to secure the outer shell around the female body at the first end.

16. The coupler assembly of claim 15, wherein the outer shell is coupled around the female body through the engagement of the plurality of fingers with the annular rim, which limits movement of the outer shell in a direction toward the second end, and through the engagement of the block with the annular ledge, which limits movement of the outer shell in a direction toward the first end.

17. A coupler assembly, comprising:
a female body;
an outer shell movably enclosing the female body;
a male body engageable within the female body; and
a means for bidirectionally rotatably disengaging the male body from within the female body.

18. The coupler assembly of claim 17, wherein the bidirectional disengagement means are configured so that a one-quarter bidirectional rotation of the outer shell relative to the male body releases the male body from within the female body.

19. The coupler assembly of claim 18, wherein the female body further comprises an internal means for removably engaging the male body within the female body, wherein the one-quarter bidirectional rotation of the bidirectional disengagement means causes the internal locking means to disengage.

20. The coupler assembly of claim 17, wherein the male body is configured to be press-fit into the female body.
